(19) United States
(12) Patent Application Publication
(10) Pub. No.: US 2019/0286320 A1
(43) Pub. Date: Sep. 19, 2019

(54) CONTROL METHOD AND APPARATUS FOR DISPLAY SCREEN

(71) Applicant: SHENZHEN ROYOLE TECHNOLOGIES CO., LTD., Shenzhen (CN)

(72) Inventors: Chao HAN, Shenzhen (CN); Ji WANG, Shenzhen (CN); Cong ZHAO, Shenzhen (CN); Wuhua DENG, Shenzhen (CN)

(21) Appl. No.: 16/422,019

(22) Filed: May 24, 2019

Related U.S. Application Data
(63) Continuation of application No. PCT/CN2016/112589, filed on Dec. 28, 2016.

(51) Int. Cl. G06F 3/0488; G09G 3/3225; G06F 3/041; G06K 9/00

(52) U.S. Cl. CPC G06F 3/04886; G09G 3/3225; G06F 3/0416; G09G 2360/145; G06F 2203/04102; G06F 2203/04803; G09G 2370/18; G06K 9/00087

(57) ABSTRACT

A control method and apparatus for display screen. The control method for the display screen comprises: a terminal device detects bending positions of the display screen; divides the display screen into a plurality of display areas according to the bending positions; determines a target display area to be displayed from the plurality of display areas; controls the target display area to display, and controls a display state, and a response state in response to a touch operation of a non-target display area according to a display state of the display screen, the non-target display area refers to the plurality of display areas except the target display area. The control method for the display screen can eliminate an image display overlap caused by a bending of the display screen, and can also reduce a probability of misoperation and a power consumption of the display screen.

### CROSS-REFERENCE TO RELATED APPLICATION

This application is a continuation of PCT/CN2016/112589, filed on Dec. 28, 2016, the disclosure of which is hereby incorporated by reference in its entirety.

### TECHNICAL FIELD

This present disclosure relates to a field of electronic technologies, and more particularly to a control method and an apparatus for a display screen.

### BACKGROUND

Flexible display screens have been deployed to more and more terminal devices (such as smart phones, tablets, smart wearable devices, etc.) for the characteristics of lightweight, thinness, foldability, breakage-proof, portability, etc. With the development of flexible display technology, the flexible display screen can not only be bent with a small fixed curvature, but also be bent freely with a large curvature or even winded. During actual use of the flexible display screen, the user can bend the flexible display screen to facilitate holding according to requirements, and the flexible display screen is divided into two or more display areas after being bent. However, after the flexible display screen is bent, it is likely to cause display contents in different display areas to coincide, and it is easy to cause misoperation when a bent flexible display screen is held by hand.

### SUMMARY

The embodiments of the present disclosure disclose a control method and apparatus for display screen, which can eliminate an image display overlap caused by a bending of the display screen, and can also reduce a probability of misoperation and a power consumption of the display screen.

A first aspect of the embodiments of the present disclosure discloses a control method for a display screen, including following steps.

Bending positions of the display screen is detected.

The display screen is divided into a plurality of display areas according to the bending positions.

A target display area to be displayed is determined from the plurality of display areas.

The target display area is controlled to be displayed, and a display state and a response state in response to a touch operation of a non-target display area are controlled according to a display state of the display screen, the non-target display area referring to the plurality of display areas except the target display area.

A second aspect of the embodiments of the present disclosure discloses a control apparatus for display screen, including a detecting module, a dividing module, a determining module, and a controlling module.

The detecting module is configured to detect bending positions of the display screen.

The dividing module is configured to divide the display screen into a plurality of display areas according to the bending positions.

The determining module is configured to determine a target display area to be displayed from the plurality of display areas.

The controlling module is configured to control the target display area to display, and control a display state, and a response state in response to a touch operation of a non-target display area according to a display state of the display screen, the non-target display area referring to the plurality of display areas except the target display area.

A second aspect of the embodiments of the present disclosure discloses a non-transitory computer-readable storage medium storing at least one computer program which, when executed by a processor, causes the processor to carry out actions: detecting bending positions of the display screen; dividing the display screen into a plurality of display areas according to the bending positions; determining a target display area to be displayed from the plurality of display areas; controlling the target display area to display, and controlling a display state, and a response state in response to a touch operation of a non-target display area according to a display state of the display screen, the non-target display area referring to the plurality of display areas except the target display area.

The embodiments of the present disclosure can detect bending positions of the display screen, divide the display screen into a plurality of display areas according to the bending positions, determine a target display area to be displayed from the plurality of display areas, control the target display area to display, and control a display state and a response state in response to a touch operation of a non-target display area according to a display state of the display screen, the non-target display area referring to the plurality of display areas except the target display area. Therefore, the image display overlap caused by the bending of the display screen can be eliminated, and the probability of misoperation and the power consumption of the display screen can be reduced.

### BRIEF DESCRIPTION OF THE ACCOMPANYING DRAWINGS

To describe technology solutions in the embodiments of the present disclosure more clearly, the following briefly introduces the accompanying drawings required for describing the embodiments. Obviously, the accompanying drawings in the following description show merely some embodiments of the present disclosure, those of ordinary skill in the art may also derive other obvious variations based on these accompanying drawings without creative efforts.

FIG. 1 is a schematic flowchart of a control method of a display screen according to one embodiment of the present disclosure;

FIG. 2a is a schematic structural diagram of a display screen according to one embodiment of the present disclosure;

FIG. 2b is a schematic structural diagram of bending positions detecting module according to one embodiment of the present disclosure;

FIG. 2c is a schematic diagram of a principle of total reflection disclosed in one embodiment of the present disclosure;

FIG. 3 is a schematic structural diagram of a control apparatus for display screen according to one embodiment of the present disclosure.

FIG. 4 is a block diagram of a control apparatus for display screen according to one embodiment of the present disclosure.

### DETAILED DESCRIPTION OF ILLUSTRATED EMBODIMENTS

The technical solution in the embodiments of the present disclosure will be described clearly and completely hereinafter with reference to the accompanying drawings in the embodiments of the present disclosure. Obviously, the described embodiments are merely some but not all the embodiments of the present disclosure. All other embodiments obtained by a person of ordinary skilled in the art based on the embodiments of the present disclosure without creative efforts shall all fall within the protection scope of the present disclosure.

The embodiments of the present disclosure disclose a control method and apparatus for a display screen, which can eliminate an image display overlap caused by a bending of the display screen, and reduce a probability of misoperation and a power consumption of the display screen.

The terminal device described in the embodiments of the present disclosure may specifically include, but is not limited to, a smart phone, a tablet, a smart wearable device, an in-vehicle terminal, and the like equipped with a flexible display screen.

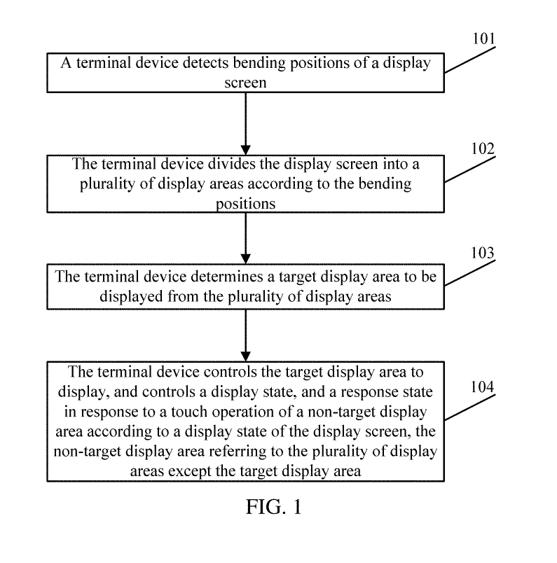

Referring to FIG. 1, a schematic flowchart of a control method of a display screen according to one embodiment of the present disclosure is illustrated. The control method of the display screen described in this embodiment includes:

At step 101, the terminal device detects bending positions of the display screen. The display screen described in the embodiments of the present disclosure may be a flexible display screen, such as an organic light-emitting diode (OLED) flexible display screen.

In a specific implementation, a bending position detection module is disposed on the display screen of the terminal device. The bending position detection module detects bending positions of the display screen to generate detection data. The terminal device obtains the detection data from the bending position detection module, and determines the bending positions of the display screen according to the detection data.

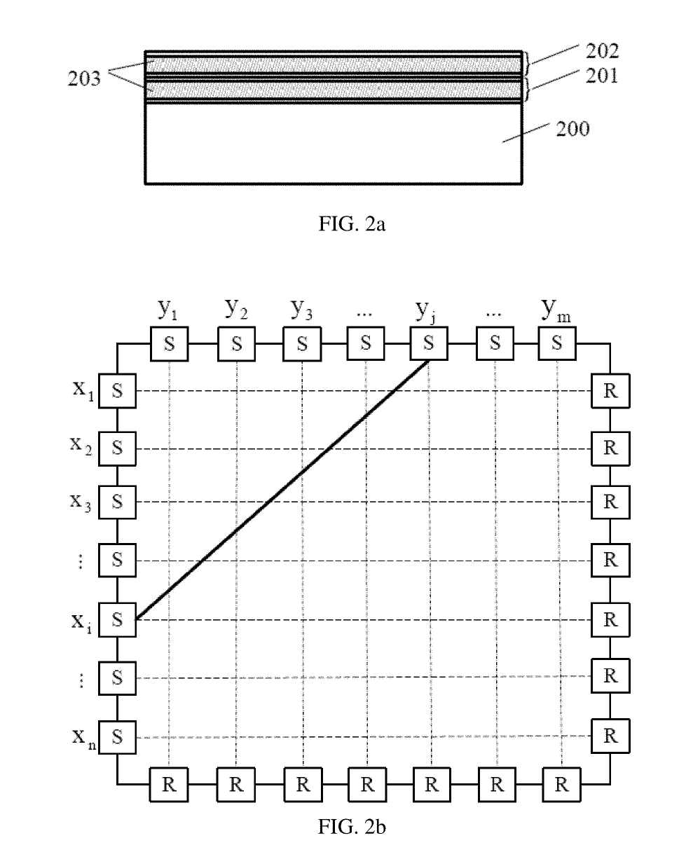

In some possible implementations, a structure of the display screen may be specifically shown in FIG. 2a. The display screen 200 is covered with a first film layer 201 and a second film layer 202. Of course, positions of the first film layer 201 and the second film layer 202 may be exchanged. The bending position detecting module may be specifically disposed on the first film layer 201 and the second film layer 202. The bending position detecting module includes a plurality of light emitting units and a plurality of corresponding light receiving units arranged along a first direction on the first film layer 201, a plurality of light emitting units and a plurality of corresponding light receiving units arranged along a second direction on the second film layer 202. The light emitting units are disposed at one end of the first film layer 201 or the second film layer 202, and the light receiving units, which are opposite to the light emitting units, are disposed at the other end of the first film layer 201 or the second film layer 202. Where, the first direction is not parallel to the second direction. Preferably, the first direction and the second direction are perpendicular to each other. At this time, a structure of the bending position detecting module may be specifically shown in FIG. 2b, and it is assumed that a plane in which the bending position detecting modules x₁˜xₙ are located corresponds to the first film layer 201; a plane in which the bending position detecting modules y₁˜yₙ are located corresponds to the second film layer 202. Taking the bending position detection module x₁ as an example, it is assumed that the light emitting unit, denoted by S, is located at a left end of x₁ and the light receiving unit, denoted by R, is located at a right end of x₁, when a display area corresponding to x₁ is not bent, the light receiving unit R located at the right end can receive an optical signal emitted by the light emitting unit S located at the left end. Similarly, taking the bending position detecting module y₁ as an example, it is assumed that the light emitting unit S is located at a top end of y₁ and the light receiving unit R is located at a bottom end of y₁, when a display screen area corresponding to y₁ is not bent, the light receiving unit R located at the bottom end can receive an optical signal emitted by the light emitting unit S located at the top end.

The terminal device can control all the light emitting units S of the first film layer 201 and the second film layer 202 to emit optical signals, and the corresponding light receiving units R of the first film layer 201 and the second film layer 202 can receive the optical signals. The light receiving units R each can generate a feedback signal correspondingly according to whether the optical signal is received. For example, the feedback signal 1 is generated when the optical signal is received, and the feedback signal 0 is generated when the optical signal is not received. It is assumed that the feedback signals generated by the light receiving units R of the bending position detection modules x₁˜xᵢ of the first film layer 201 in FIG. 2b are 0; the feedback signals generated by the light receiving units R of x₍ᵢ₊₁₎˜xₙ are 1; the feedback signals generated by the light receiving units R of the bending position detecting modules y₁˜yⱼ of the second film layer 202 are 0; and the feedback signals generated by the light receiving units R of y₍ⱼ₊₁₎˜yₘ are 1; then the terminal device uses the feedback signals as the detection data, and obtains coordinates of the bending position detection modules x₁˜xᵢ, y₁˜yⱼ of which the feedback signals are 0 in the display screen 200 according to the detection data, determines a connecting line between a position of the light emitting unit S of the bending position detecting module x, and a position of the light emitting unit S of the bending position detecting module y, as the bending position of the display screen 200 after superimposing the coordinates of x₁˜xᵢ and y₁˜yⱼ, as shown by an oblique line in FIG. 2b.

In some possible implementations, light guiding layers 203 are disposed in the first film layer 201 and the second film layer 202. As shown in FIG. 2a, when the display screen 200 is unfolded, the optical signals emitted by the light emitting units S are transmitted to the light receiving units R through the light guiding layers 203.

In some possible implementations, each light guiding layer 203 can include at least one optically denser layer and at least one optically thinner layer. When the display screen 200 is not bent, the optical signals emitted by the light emitting units S are totally reflected in the light guiding layers 203 and transmitted to the light receiving units R. When the display screen 200 is bent toward a side away from the optically thinner layer, if a bending angle of the display screen 200 is less than a first bending angle threshold, the optical signals are still reflected in the light guiding layers 203 in total reflection and transmitted to the light receiving units R. If the bending angle is not less than the first bending angle threshold, the optical signals cannot be reflected in the light guiding layers 203 in total reflection and cannot be transmitted to the light receiving units R.

In some possible implementations, each light guiding layer 203 can include at least one optically denser layer and at least two optically thinner layers; and the at least two optically thinner layers are disposed on an upper side and a lower side of the at least one optically denser layer. When the display screen 200 is not bent, the optical signals emitted by the light emitting units S are reflected in the light guiding layer 203 in total reflection and transmitted to the light receiving units R. When the display screen 200 is bent toward the upper optically thinner layer or the lower optically thinner layer, if the bending angle of the display screen 200 is less than a second bending angle threshold, the optical signals are then still reflected in the light guiding layers 203 in total reflection and are transmitted to the light receiving units R. If the bending angle is not less than the second bend angle threshold, the optical signals cannot be totally reflected in the light guiding layers 203 and cannot be transmitted to the light receiving units R.

For example, in the above embodiment, each light guiding layer includes one optionally denser layer and two optionally thinner layers. As shown in FIG. 2c, the light guiding layer is a step-index fiber with a fibre core, which is the optionally denser layer, and a clad layer, which is the optionally thinner layer. A refractive index of the fibre core is larger than that of the clad layer. It is assumed that a critical angle of total reflection of an optical line at an interface between the fibre core and the clad layer is θ_{c}, an incident angle of the optical line at the interface between the fiber core and the clad layer θ_{c}, a minimum value of an incident angle of the optical line at the interface between an air and the fiber core θₘₐₓ, the incident angle θᵢ of the optical signals emitted by the light emitting units S at the interface between the fiber core and the clad layer less than θₘₐₓ, the optical signals can be transmitted in the fiber core in total reflection and received by the corresponding light receiving units R.

It can be seen that when the display screen 200 is bent, and the bending angle (ie, a bending amplitude) reaches the first bending angle threshold or the second bending angle threshold, the incident angle θᵢ of the optional signals emitted by the light emitting units S at the interface between the fiber core and the clad layer is greater than or equal to θₘₐₓ, so that the optical signals can be emitted from the fiber core, causing that the corresponding light receiving units R receive no optical signals. Setting the first bending angle threshold and the second bending angle threshold can prevent the terminal device from erroneous determination when the display screen is being bent slightly, so as to prevent the terminal device from malfunctioning.

It can be understood that different difference values between refractive indexes of the optically denser layer and the optically thinner layer may cause the first bending angle threshold and the second bending angle threshold to be different, that is, the first bending angle threshold and the second bending angle threshold are related to the difference value between refractive indexes of the optically dense layer and the optional thinner layer.

At step 102, the terminal device divides the display screen into a plurality of display areas according to the bending positions.

In a specific implementation, the terminal device can divide the display screen into a plurality of display areas by the bending positions and the edge of the display screen. When there is only one bending position, then the display screen can be divided into two display areas, as shown in FIG. 2b. When there is only one bending position indicated by a diagonal line, the terminal device can divide the display screen into two display areas, that is: a display area enclosed by the bending position detection modules x₁˜xᵢ, y₁˜yⱼ and the diagonal line and a remaining display area in the display screen.

Furthermore, when there are a plurality of bending positions, the terminal device may divide the display screen into a plurality of display areas by a bending position and an adjacent bending position, and a bending position and an edge of the display screen.

At step 103, the terminal device determines a target display area to be displayed from the plurality of display areas.

The target display area to be displayed is a display area that the user needs to use. The display screen in the embodiments of the present disclosure may have a fingerprint identification function by including a fingerprint identification unit. The specific manner in which the terminal device determines the target display area may be: the terminal device can determine the display area where a designated finger is located as the target display area according to a fingerprint recognition and matching of the designated finger of the user, including: a fingerprint of the designated finger of the user (for example, a thumb) is pre-recorded as a preset fingerprint, and the terminal device reads a fingerprint detected by a fingerprint identification unit of the display screen in real time, matches the fingerprint with the preset fingerprint, when a matching degree reaches a preset value (for example, 95%), it is determined that the user inputs the preset fingerprint, and a position of the current fingerprint is obtained, the display area where the fingerprint is located is determined according to the position of the fingerprint, the display area where the fingerprint is located in the plurality of display areas can be thus determined as the target display area to be displayed.

Furthermore, the terminal device may determine the target display area according to a time duration of the fingerprint in the display area. When the terminal device determines that the matching degree between the fingerprint and the preset fingerprint reaches a preset value, a time duration of the fingerprint acting on the display area is determined whether it is up to a preset time duration (for example, 2 s). When the time duration is reached to the preset time duration, the terminal device can determine the display area where the fingerprint is located as the target display area to be displayed, so that the target display area to be displayed can be determined more accurately.

In some possible implementations, the terminal device may further determine the target display area according to a focus position of a user's eye, including: the terminal device captures a user's eye through a camera device; determines a focus position of the eye in the display screen by using the eye data captured by the camera device; determines a display area where the focus position of the eye is located; and determines the display area where the focus position of the eye is located from the plurality of display areas as the target display area to be displayed. For example, the terminal device captures a face image through a front camera, performs eye positioning on the face image, records eye image data, and obtains an angle between a focus direction of the eye and a plane in which the display screen is located according to the eye image data. The distance between the eye and the display screen can be determined by a distance sensor or the like. The focus position of the eye in the display screen can be determined according to the angle and the distance. For another example, the user can wear an eye tracker, and the eye tracker transmits real-time eye tracking data to the terminal device, and the terminal device can determine the focus position of the eye in the display screen according to the eye tracking data.

Furthermore, the terminal device may determine the target display area according to a time duration of the eye focusing on a certain position in the display screen. After determining the display area where the focus position of the eye is located, the terminal device determines whether a time duration of the focus duration of the eye reaches a preset time duration (for example, 2 s). When the preset time duration is reached, the terminal device can determine the display area where the focus position of the eye is located as the target display area to be displayed, thereby the target display area to be displayed is determined more accurately.

At step 104, the terminal device controls the target display area to display, and controls a display state, and a response state in response to a touch operation of a non-target display area according to a display state of the display screen, the non-target display area referring to the plurality of display areas except the target display area.

In the specific implementation, the terminal device obtains the display state of the display screen. When the display state of the display screen is on, the terminal device keeps displaying the target display area, disenables the non-target display area, which refers to the plurality of display areas except the target display area, to display and disenables the non-target display area to respond to the touch operation applied thereto, so as to avoid the image display overlap, reduce the power consumption of the display screen, and extend a battery life of the terminal device. Disenabling the non-target display area to respond to the touch operation applied thereto can avoid misoperation when the user touches the non-target display area accidentally.

When the display state of the display screen is off, the terminal device enables the target display area to display, and responds to the touch operation applied to the target display area, disenables the non-target display area to display, and disenables the non-target display area to respond to the touch operation applied thereto, thereby ensuring the displaying of the target display area that the user needs to use, responding to the touch operation applied to the target display area, avoiding the image display overlap, reducing the power consumption of the display screen, extending the battery life of the terminal device and avoiding misoperation when the user touches the non-target display area accidentally.

The specific manner in which the terminal device disenables the non-target display area, which refers to the plurality of display areas except the target display area, to display, may be: before the terminal device transmits the display data to the display screen, the red, green, and blue values of each pixel included in the non-target display area are set to zero. After receiving the display data, the display screen sets the RGB value of each pixel in the non-target display area to zero, thereby disenabling the non-target display area to display.

The specific manner in which the terminal device disenables the non-target display area to respond to the touch operation applied thereto, may be: when the display screen detects that the user inputs a touch operation, an acting position of the touch operation is transmitted to the terminal device; when the terminal device determines that the acting position is within a range of the non-target display area, the terminal device may not respond to the touch operation; when the acting position is within a range of the target display area, the terminal device responses the touch operation normally.

In the embodiments of the present disclosure, the terminal device detects bending positions of the display screen; divides the display screen into a plurality of display areas according to the bending positions; determines a target display area to be displayed from the plurality of display areas; controls the target display area to display; and controls a display state, and a response state in response to a touch operation of a non-target display area according to the display state of the display screen, the non-target display area referring to the plurality of display areas except the target display area, thereby eliminating image display overlap caused by the bending of the display screen, and reducing the probability of misoperation and the power consumption of the display screen.

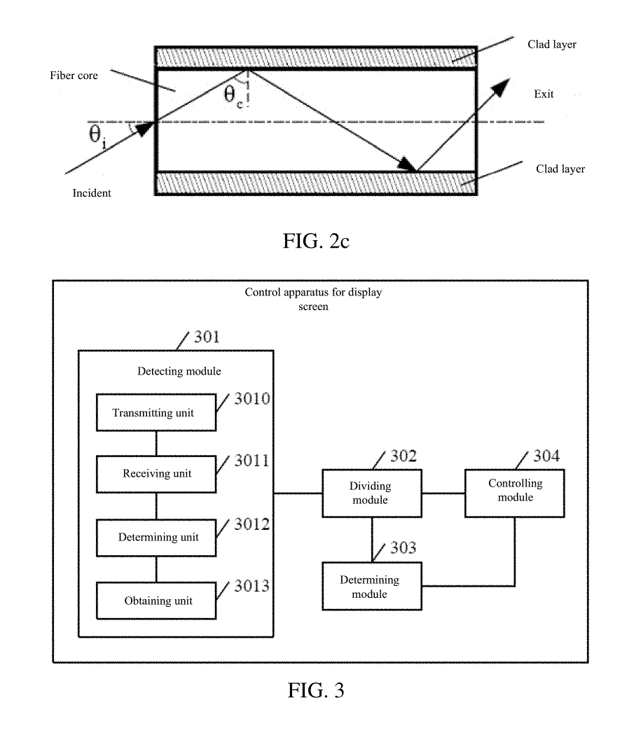

FIG. 3 is a schematic structural diagram of a control apparatus for display screen according to one embodiment of the present disclosure. The control apparatus for the display screen described in this embodiment includes a detecting module 301, a dividing module 302, a determining module 303 and a controlling module 304.

The detecting module 301 is configured to detect bending positions of the display screen.

The dividing module 302 is configured to divide the display screen into a plurality of display areas according to the bending positions.

The determining module 303 is configured to determine a target display area to be displayed from the plurality of display areas.

The controlling module 304 is configured to control the target display area to display, and control a display state, and a response state in response to a touch operation of a non-target display area according to a display state of the display screen, the non-target display area referring to the plurality of display areas except the target display area.

In some specific implementations, the controlling module 304 is specifically configured to:

when the display state of the display screen is on, keep displaying the target display area, and disenable the non-target display area to respond to the touch operation applied to the non-target display area, the non-target display area referring to the plurality of display areas except the target display area;

when the display state of the display screen is off, disenable the target display area to respond to the touch operation applied to the target display area.

In some specific implementations, the detecting module 301 includes a transmitting unit 3010, a receiving unit 3011, a determining unit 3012 and an obtaining unit 3013.

The transmitting unit 3010 is configured to emit first optical signals by using a plurality of light emitting units arranged along a first direction on a first film layer of the display screen.

The receiving unit 3011 is configured to receive the first optical signals by using a plurality of light receiving units arranged along the first direction on the first film layer.

The transmitting unit 3010 is further configured to emit second optical signals by using a plurality of light emitting units arranged along a second direction on a second film layer of the display screen.

The receiving unit 3011 is further configured to receive the second optical signals by using the plurality of light receiving units arranged along the second direction on the second film layer.

The determining unit 3012 is further configured to determine the light receiving units which fail to receive the first optical signals on the first film layer as first target light receiving units, and the light receiving units which fail to receive the second optical signals on the second film layer as second target light receiving units.

The obtaining unit 3013 is configured to obtain feedback signals of the first target light receiving units and the second target light receiving units.

The determining unit 3012 is further configured to determine the bending positions of the display screen according to the feedback signals.

In some specific implementations, light guiding layers are disposed in the first film layer and the second film layer. When the display screen is unfolded, the first optical signals and the second optical signals emitted by the light emitting units are transmitted to the light receiving units through the light guiding layers.

In some possible implementations, each light guiding layer includes at least one optically denser layer and at least one optically thinner layer. When the first bending angle of the display screen is less than the first bending angle threshold, the first optical signals and the second optical signals are reflected in the light guiding layer in total reflection and transmitted to the light receiving units.

When the first bending angle is not less than the first bending angle threshold, the first optical signals and the second optical signals in the light guiding layers fail to be transmitted to the light receiving units.

In some possible implementations, each light guiding layer includes at least one optically denser layer and at least two optically thinner layers; the at least two optically thinner layers are disposed on an upper side and a lower side of the at least one optically denser layer; when the second bending angle of the display screen is less than the second bending angle threshold, the first optical signals and the second optical signals are reflected in the light guiding layers in total reflection and transmitted to the light receiving units.

When the second bending angle is not less than the second bending angle threshold, the first optical signals and the second optical signals in the light guiding layers fail to be transmitted to the light receiving units.

In some possible implementations, the determining module 303 is specifically configured to:

identify a fingerprint input through the display screen;

obtain a display area where the fingerprint is located when the fingerprint matches a preset fingerprint;

determine the display area where the fingerprint is located from the plurality of display areas as the target display area to be displayed.

In some possible implementations, the determining module 303 is specifically configured to:

capture an eye and obtain a focus position of the eye in the display screen;

determine a display area where the focus position is located;

determine the display area where the focus position is located from the plurality of display areas as the target display area to be displayed.

In some possible implementations, the controlling module 304 is specifically configured to:

set RGB values of red, green and blue of each pixel included in the non-target display area, which refers to the display areas except the target display area, in display data transmitted to the display screen, to zero, so as to disenable the non-target display area to display.

In some possible implementations, the controlling module 304 is specifically configured to:

obtain an acting position of the touch operation acting on the display screen;

not respond to the touch operation when the acting position is in the non-target display area.

It can be understood that functions of function modules and units of the control apparatus of the display screen of the present embodiment may be specifically implemented according to a method in the foregoing method embodiment, and its specific implementation process refers to related description of the foregoing method embodiment, no more details here.

In the embodiment of the present disclosure, the detecting module 301 detects the bending positions of the display screen, and the dividing module 302 divides the display screen into a plurality of display areas according to the bending positions, and the determining module 303 determines the target display area to be displayed from the plurality of display areas, and the controlling module 304 controls the display area to display, and controls a display state, and a response state in response to the touch operation of the non-target display area according to the display state of the display screen, the non-target display area referring to the plurality of display areas except the target display area, thereby eliminating the image display overlap caused by the bending of the display screen, and reducing the probability of misoperation and the power consumption of the display screen.

It should be noted that, for the foregoing various method embodiments, for the sake of brevity, they are all described as a series of action combinations, but those skilled in the art should understand that the present disclosure is not limited by a described acting sequence, because certain steps may be performed in other sequences or concurrently in accordance with the present disclosure. Secondly, those skilled in the art should also understand that the embodiments described in the specification are all preferred embodiments, and the actions and modules involved are not necessarily required by the present disclosure.

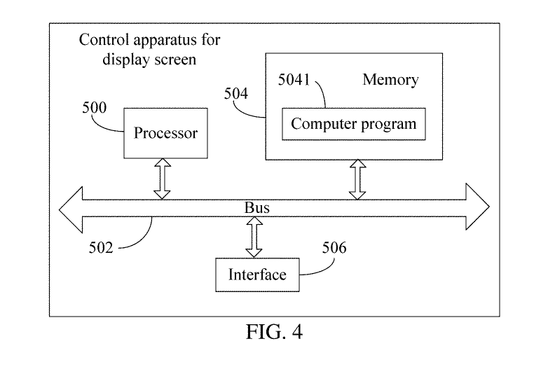

As illustrated in FIG. 4, these components illustrated in FIG. 3 can be integrated into a processor 500 for example. The processor 500 may be coupled to a memory 504 and at least one interface 506 by a bus 502. The memory 504 is configured to store at least one computer program 5041 which, when executed by the processor 500, becomes operable with the processor 500 to carry out the methods of the embodiments of the present disclosure. In addition, coupling or communication connection between each illustrated or discussed component may be direct coupling or communication connection, or may be indirect coupling or communication among devices or units by the at least one interface 506, and may be electrical connection, mechanical connection, or other forms of connection.

A person skilled in the art may understand that all or part of the steps of the foregoing embodiments may be implemented by a program to instruct related hardware. The program may be stored in a computer readable storage medium, and the storage medium may include: a Flash disk, a read-only memory (ROM), a random access memory (RAM), a disk, an optical disk or the like.

The above is a preferred embodiment of the present disclosure, and it should be noted that those skilled in the art may make some improvements and modifications without departing from the principle of the present disclosure, and these improvements and modifications are also the protection scope of the present disclosure.

What is claimed is:

1. A control method for a display screen, comprising:
detecting bending positions of the display screen;
dividing the display screen into a plurality of display areas according to the bending positions;
determining a target display area to be displayed from the plurality of display areas;
controlling the target display area to display, and controlling a display state, and a response state in response to a touch operation of a non-target display area according to a display state of the display screen, the non-target display area referring to the plurality of display areas except the target display area.

2. The method according to claim 1, wherein, controlling the target display area to display, and controlling the display state, and the response state in response to the touch operation of the non-target display area according to the display state of the display screen, the non-target display area referring to the plurality of display areas except the target display area, comprises:
when the display state of the display screen is on, keeping displaying the target display area, and disenabling the non-target display area, which refers to the plurality of display areas except the target display area, to display, and disenabling the non-target display area to respond to the touch operation applied thereto;
when the display state of the display screen is off, enabling the target display area to display, and responding to the touch operation applied to the target display area.

3. The method according to claim 1, wherein, detecting the bending positions of the display screen, comprises:
transmitting first optical signals emitted by a plurality of light emitting units arranged along a first direction on a first film layer of the display screen, and receiving the first optical signals by a plurality of light receiving units arranged along the first direction on the first film layer;
transmitting second optical signals emitted by a plurality of light emitting units arranged along a second direction on a second film layer of the display screen, and receiving the second optical signals by the plurality of light receiving units arranged along the second direction on the second film layer;
determining the light receiving units which fail to receive the first optical signals on the first film layer as first target light receiving units, and determining the light receiving units which fail to receive the second optical signals on the second film layer as second target light receiving units;
obtaining feedback signals of the first target light receiving units and the second target light receiving units;
determining the bending positions of the display screen according to the feedback signals.

4. The method according to claim 3, wherein,
disposing light guiding layers in the first film layer and the second film layer;
transmitting the first optical signals and the second optical signals emitted by the light emitting units to the light receiving units through the light guiding layers when the display screen is unfolded.

5. The method according to claim 4, wherein,
each light guiding layer comprises at least one optically denser layer and at least one optically thinner layer; when a first bending angle of the display screen is less than a first bending angle threshold, the first optical signals and the second optical signals are reflected in the light guiding layers in total reflection and transmitted to the light receiving units;
when the first bending angle is not less than the first bending angle threshold, the first optical signals and the second optical signals in the light guiding layers fail to be transmitted to the light receiving units.

6. The method according to claim 4, wherein,
the light guiding layer comprises at least one optically denser layer and at least two optically thinner layers, the at least two optically thinner layers disposed on an upper side and a lower side of the at least one optically denser layer; when a second bending angle of the display screen is less than a second bending angle threshold, the first optical signals and the second optical signals are reflected in the light guiding layers in total reflection and transmitted to the light receiving units;
when the second bending angle is not less than the second bending angle threshold, the first optical signals and the second optical signals in the light guiding layers fail to be transmitted to the light receiving units.

7. The method according to claim 3, wherein, determining the target display area to be displayed from the plurality of display areas, comprises:
identifying a fingerprint input through the display screen;
obtaining a display area where the fingerprint is located when the fingerprint matches a preset fingerprint;
determining the display area where the fingerprint is located from the plurality of display areas as the target display area to be displayed.

8. The method of claim 2, wherein, disenabling the non-target display area to respond to the touch operation applied thereto, comprises:
obtaining an acting position of the touch operation acting on the display screen;
not responding to the touch operation when the acting position is in the non-target display area.

9. A control apparatus for display screen, comprising a processor, a memory, and a bus, the processor being coupled to the memory by the bus, the memory being configured to store at least one computer program which, when executed by the processor, becomes operational with the processor to:
detect bending positions of the display screen;
divide the display screen into a plurality of display areas according to the bending positions;
determine a target display area to be displayed from the plurality of display areas;
control the target display area to display, and control a display state, and a response state in response to a touch operation of a non-target display area according to a display state of the display screen, the non-target display area referring to the plurality of display areas except the target display area.

10. The apparatus according to claim 9, wherein, the computer program, when executed by the processor, becomes operational with the processor to:
when the display state of the display screen is on, keep displaying the target display area, and disenable the non-target display area, which refers to the plurality of display areas except the target display area, to display, and disenable the touch operation to respond to the touch operation applied thereto;
when the display state of the display screen is off, enable the target display area to display, and respond to the touch operation applied to the target display area.

11. The apparatus according to claim 9, wherein, the computer program, when executed by the processor, becomes operational with the processor to:
emit first optical signals by using a plurality of light emitting units arranged along a first direction on a first film layer of the display screen;
receive the first optical signals by using a plurality of light receiving units arranged along the first direction on the first film layer;
emit second optical signals by using a plurality of light emitting units arranged along a second direction on a second film layer of the display screen;
receive the second optical signals by using the plurality of light receiving units arranged along the second direction on the second film layer;
determine the light receiving units which fail to receive the first optical signals on the first film layer as first target light receiving units, and determine the light receiving units which fail to receive the second optical signals as second target light receiving units;
obtain feedback signals of the first target light receiving units and the second target light receiving units;
determine the bending positions of the display screen according to the feedback signals.

12. The apparatus according to claim 11, wherein,
light guiding layers is disposed in the first film layer and the second film layer, when the display screen is unfolded, the first optical signals and the second optical signals emitted by the light emitting unit are transmitted to the light receiving unit through the light guiding layers.

13. The apparatus according to claim 12, wherein,
the light guiding layer comprises at least one optically denser layer and at least one optically thinner layer; when a first bending angle of the display screen is less than a first bending angle threshold, the first optical signals and the second optical signals are reflected in the light guiding layers in total reflection and transmitted to the light receiving units;
when the first bending angle is not less than the first bending angle threshold, the first optical signals and the second optical signals in the light guiding layers fail to be transmitted to the light receiving units.

14. The apparatus according to claim 12, wherein,
each light guiding layer comprises at least one optically denser layer and at least two optically thinner layers, the at least two optically thinner layers disposed on an upper side and a lower side of the at least one optically denser layer; when a second bending angle of the display screen is less than a second bending angle threshold, the first optical signals and the second optical signals are reflected in the light guiding layers in total refection and transmitted to the light receiving units;
when the second bending angle is not less than the second bending angle threshold, the first optical signals and the second optical signals in the light guiding layers fail to be transmitted to the light receiving units.

15. The apparatus according to claim 11, wherein, the computer program, when executed by the processor, becomes operational with the processor to:
identify a fingerprint input through the display screen;
obtain a display area where the fingerprint is located when the fingerprint matches a preset fingerprint;
determine the display area where the fingerprint is located from the plurality of display areas as the target display area to be displayed.

16. The apparatus according to claim 10, wherein, the computer program, when executed by the processor, becomes operational with the processor to:
obtain an acting position of the touch operation acting on the display screen;
not respond to the touch operation when the acting position is in the non-target display area.

17. A non-transitory computer-readable storage medium storing at least one computer program which, when executed by a processor, causes the processor to carry out actions:
detecting bending positions of the display screen;
dividing the display screen into a plurality of display areas according to the bending positions;
determining a target display area to be displayed from the plurality of display areas;
controlling the target display area to display, and controlling a display state, and a response state in response to a touch operation of a non-target display area according to a display state of the display screen, the non-target display area referring to the plurality of display areas except the target display area.

18. The non-transitory computer-readable storage medium according to claim 17, wherein, controlling the target display area to display, and controlling the display state, and the response state in response to the touch operation of the non-target display area according to the display state of the display screen, the non-target display area referring to the plurality of display areas except the target display area, comprises:
when the display state of the display screen is on, keeping displaying the target display area, and disenabling the non-target display area, which refers to the plurality of display areas except the target display area, to display, and disenabling the non-target display area to respond to the touch operation applied thereto;
when the display state of the display screen is off, enabling the target display area to display, and responding to the touch operation applied to the target display area.

19. The non-transitory computer-readable storage medium according to claim 17, wherein, detecting the bending positions of the display screen, comprises:
transmitting first optical signals emitted by a plurality of light emitting units arranged along a first direction on a first film layer of the display screen, and receiving the first optical signals by a plurality of light receiving units arranged along the first direction on the first film layer;
transmitting second optical signals emitted by a plurality of light emitting units arranged along a second direction on a second film layer of the display screen, and receiving the second optical signals by the plurality of light receiving units arranged along the second direction on the second film layer;
determining the light receiving units which fail to receive the first optical signals on the first film layer as first target light receiving units, and determining the light receiving units which fail to receive the second optical signals on the second film layer as second target light receiving units;
obtaining feedback signals of the first target light receiving units and the second target light receiving units;
determining the bending positions of the display screen according to the feedback signals.

20. The non-transitory computer-readable storage medium according to claim 19, wherein,
disposing light guiding layers in the first film layer and the second film layer;
transmitting the first optical signals and the second optical signals emitted by the light emitting units to the light receiving units through the light guiding layers when the display screen is unfolded.

21. The non-transitory computer-readable storage medium according to claim 20, wherein,
each light guiding layer comprises at least one optically denser layer and at least one optically thinner layer; when a first bending angle of the display screen is less than a first bending angle threshold, the first optical signals and the second optical signals are reflected in the light guiding layers in total reflection and transmitted to the light receiving units;
when the first bending angle is not less than the first bending angle threshold, the first optical signals and the second optical signals in the light guiding layers fail to be transmitted to the light receiving units.

22. The non-transitory computer-readable storage medium according to claim 20, wherein,
the light guiding layer comprises at least one optically denser layer and at least two optically thinner layers, the at least two optically thinner layers disposed on an upper side and a lower side of the at least one optically denser layer; when a second bending angle of the display screen is less than a second bending angle threshold, the first optical signals and the second optical signals are reflected in the light guiding layers in total reflection and transmitted to the light receiving units;
when the second bending angle is not less than the second bending angle threshold, the first optical signals and the second optical signals in the light guiding layers fail to be transmitted to the light receiving units.
